(19) United States
(12) Patent Application Publication
(10) Pub. No.: US 2011/0248056 A1
(43) Pub. Date: Oct. 13, 2011

(54) TIRE CASING CARRIER

(76) Inventor: Lyle Terhar, Urbandale, IA (US)

(21) Appl. No.: 12/756,452

(22) Filed: Apr. 8, 2010

(51) Int. Cl. B62D 43/02

(52) U.S. Cl. 224/42.12

(57) ABSTRACT

A tire casing carrier for carrying a tire casing under the frame of a vehicle having a pair of engagement members and a pair of lifting devices. Each engagement member has a strap extension with a free end and an opposing end which connects to a pair of support member each having a hook at their end. A locking member is connected to and arcuately extends between opposing hooks with a clamping member attached at its midpoint. The clamping devices, hooks and locking members are attached to the interior of the tire casing and tightened by the lifting devices thereby holding the tire casing in place.

### BACKGROUND OF THE INVENTION

This invention relates to a tire carrier. More specifically, and without limitation, this invention relates to a tire carrier which is removable from the vehicle and requires minimal physical effort to operate.

Many commercial vehicles have a need to carry spare wheels or tires on or under the body of the vehicle. Many of these carriers are permanently affixed or welded to the frame of the truck or trailer. Many others claim to be removable, yet one or more components of the carriers are fastened or welded to the vehicle. Thus, a need exists in the art for a removable carrier wherein no permanent fastening of the assembly to the vehicle is required and the carrier can be completely detached when not in use.

Therefore, an object of the present invention is to provide a carrier for transporting a tire that is completely removable from a container chassis.

This and other objectives will be apparent to those of ordinary skill in the art based upon the following written description, specification, drawings and claims.

### SUMMARY OF THE INVENTION

A tire casing carrier for carrying a tire casing under the frame of a vehicle having a pair of engagement members and a pair of lifting devices. Each engagement member has a strap extension with a free end and an opposing end which connects to a pair of support member each having a hook at their end. A locking member is connected to and arcuately extends between opposing hooks with a clamping member attached at its midpoint. The locking members are attached to the interior of the tire casing and tightened by the lifting devices thereby holding the tire casing in place.

### BRIEF DESCRIPTION OF THE DRAWINGS

FIG. 1 is a side elevation view of a vehicle employing the tire casing carrier;

FIG. 2 is a side elevation view of a vehicle employing the tire casing carrier;

FIG. 3 is a perspective view of a lifting device of the tire casing carrier; and

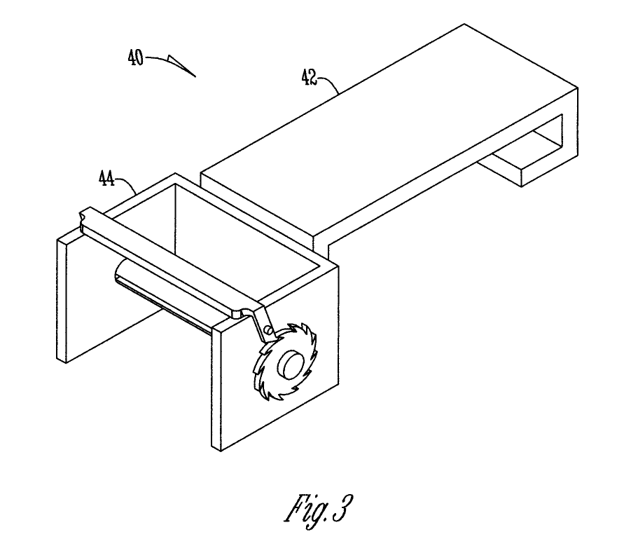

FIG. 4 is a perspective view of the engaging members of the tire casing carrier.

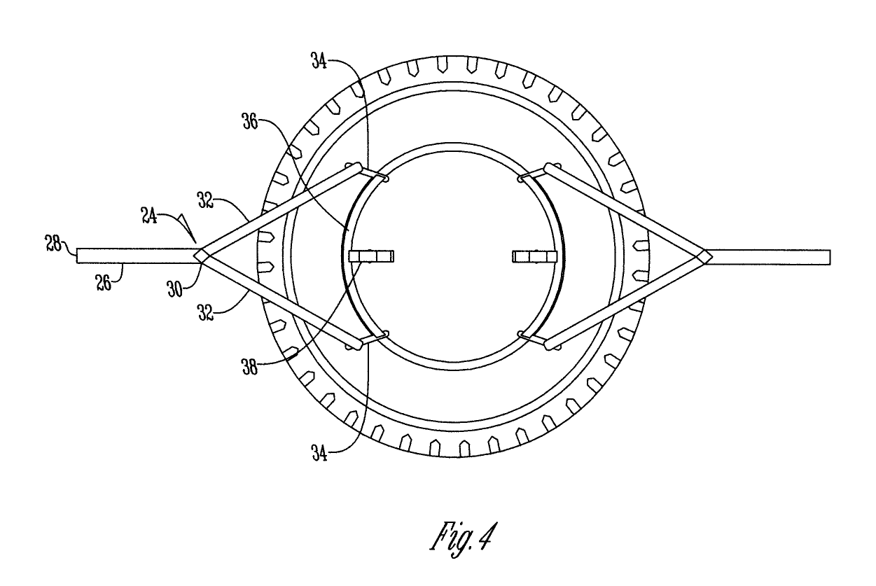

### DETAILED DESCRIPTION OF THE INVENTION

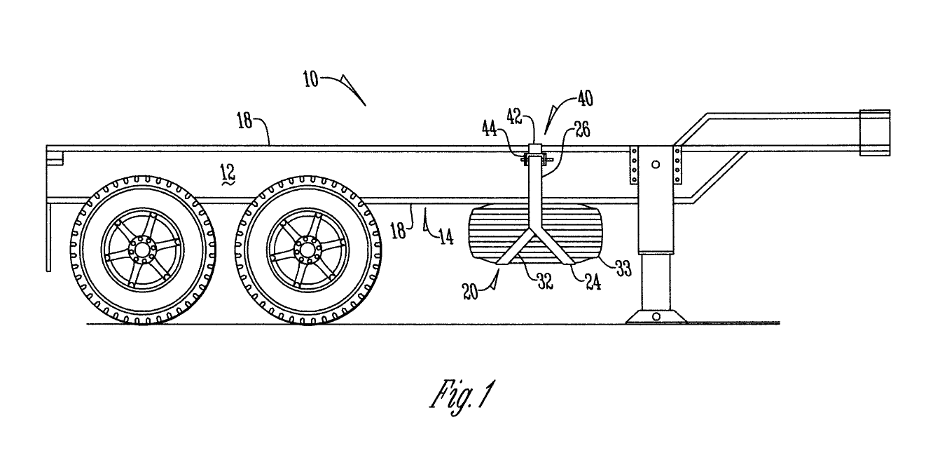

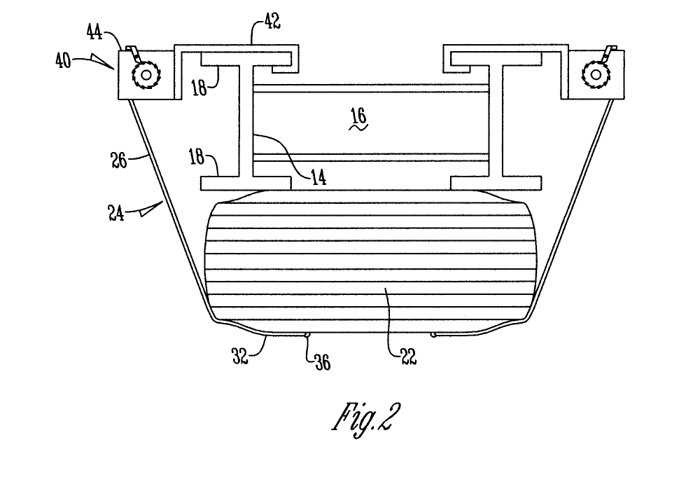

Referring to the figures, a vehicle 10 is presented having a frame 12 which includes a pair of I-beams 14 which run the a length of vehicle 10 in parallel spaced relation. Connected to and extending between I-beams 14 are a plurality cross beams 16 which provide support and rigidity to vehicle 10. I-Beams have a rail 18 positioned at the top and bottom of each I-beam 14. A tire casing carrier 20 is attached to the vehicle 10. As is seen in FIGS. 1 and 2, in a preferred embodiment, tire casing carrier 20 is connected to the vehicle 10 such that the tire casing carrier 20 is positioned and holds tire casing 22 underneath frame 12 and in contact with the bottom surface of, and equally spaced between, parallel I-beams 14. Alternatively, tire casing carrier 20 is connected to vehicle 10 in any way so as to hold tire casing 22 in any position relative to vehicle 10.

Tire casing carrier 20 preferably has a pair of engagement members 24. Each engagement member 24 begins with a strap extension 26. Strap extension 26 extends between a first end 28 which is preferably free and unattached, and a second end 28 which connects to a pair of support members 32. Support members 32 and strap extensions 26 are preferably made of any flexible member known in the art such as a rope, cable, wire or the like. Support members 32 connect to the second end 30 of strap extension 26 by any means known in the art such as sewing, gluing, welding or the like. Alternatively, strap extension 26 and support members 32 are a single continuous device, strap, rope or cable the divides at second end 30 into independent support members 32. Support members 32 are preferably of equal length, and although two support members 32 are described, additional support members 32 are hereby contemplated such as three, four or more. Support members 32 extend in angularly spaced relation to one another and connect at their end to strap hooks 34 and/or locking member 36. In one embodiment support members 32 connect to strap hooks 34 and an end of locking member 36 is welded to each strap hook 32 and extends therebetween.

Hooks 34 is hook know in the art that connects to the interior of tire casing 22. In one embodiment, locking member 36 is a metal rod having an arc shape that matches and matingly engages the interior sidewall lip or rim or bead of tire casing 22. Alternatively, locking member 36 is any configuration which connects, matingly engages or supports tire casing 22 such as a bar, a tube, a pipe, a bracket or the like. Connected to the locking member 36 is at least one clamping member 38 which engages the inner diameter of tire casing 22 thereby holding it in place. In one embodiment clamping member 38 is a spring clamp that is connected to the mid-point of the arc of locking member 36 such as by way of welding, screwing, bolting, gluing or the like. Other clamping devices are hereby contemplated such as a C-clamp, brackets, nuts and bolts and the like. The strap hooks 34, locking member 36 and clamping member 38 are oriented in such a way that they all engage the inner diameter of the tire casing 22 during use in a removable manner.

Lifting devices 40 are removably connected to vehicle 10. In one embodiment, lifting devices 40 have an L-shaped bracket 42 which is sized to slidably and removably engage the top rail 18 of I-beams 14. Connected to bracket 42 is a ratchet assembly 44. Ratchet assembly 44 is any ratcheting device known in the art such as a hand ratchet or electric winch which is sized to receive and tighten strap extension 26. When lifting device 40 is connected to I-beam 14, ratchet assembly 44 extends outwardly from vehicle 10.

In operation, a tire casing 22 is removably attached and stored under the frame 12 of a vehicle 12 by positioning tire casing 22 in an upright orientation adjacent frame 12 of vehicle 10. A pair of engagement members 24 are connected to the tire casing 22. More specifically, locking members 36 are secured to the tire casing 22 using the clamping member 38. In this position, strap hooks 34 are attached to the interior of tire casing 22 while simultaneously locking member 36 is connected to inner diameter of tire casing 22 thereby creating a tight and locking connection. Engagement members 24 are positioned and oriented on the inner diameter of the tire casing 22 opposite one another or at a 180 degree orientation to one another.

Once the locking member 36 and strap hooks 34 of the engagement members 24 are connected to the inner diameter of the tire casing 22, the tire casing 22 is horizontally aligned beneath frame 12 of vehicle 10. Next, lifting devices 40 are connected to the frame 12 of vehicle 10 by way removably engaging bracket 42 with rail 18 of I-beam 14. Lifting devices 40 are preferably positioned adjacent one another, in the same plane, along opposing I-beams 14 in opposite facing orientation to one another. That is, ratchet assemblies 44 face away from one another.

Next, second end 30, the free end, of strap extension 26 of each engagement member 24 is fed into the ratcheting assembly 44. Ratcheting assemblies 44 are ratcheted, thereby taking up the slack in strap extension 26 until the top surface of tire casing 22 engages the bottom surface of I-beams 14 preferably centered between opposing I-beams 14. In this position, ratcheting assemblies 44 are tightened such that proper tension is placed on tire casing 22 so as to firmly hold tire casing 22 in place for travel. In this position, locking member 36 is pulled tight to the interior of tire casing 22 such that the tire casing 22 cannot unintentionally fall out.

The tire casing 22 is removed from the frame 12 of vehicle 10 by consecutively releasing the ratcheting winches 32 and allowing gravity to lower the tire casing 12.

Accordingly from the above discussion it will be appreciated that the tire casing carrier described above provides a novel and useful way to attach tire casing to the frame of a vehicle that improves upon and offers many advantages over the prior art.

It will be appreciated by those skilled in the art that other various modifications could be made to the device without parting from the spirit and scope of this invention. All such modifications and changes fall within the scope of the claims and are intended to be covered thereby.

What is claimed is:

1. A tire casing carrier comprising:
a pair of lifting devices mounted to the frame of a vehicle;
an engagement member connected to each lifting device that engages a tire casing.

2. The tire casing carrier of claim 1 wherein the engagement member has a strap extension connected to at least one support member.

3. The tire casing carrier of claim 2 wherein a locking member is connected to the support member.

4. The tire casing carrier of claim 2 wherein a tire casing is connected to the locking member.

5. The tire casing carrier of claim 2 wherein the support member is connected to a hook.

6. The tire casing carrier of claim 1 wherein when a lifting device is actuated the tire casing is tightly held in contact with the vehicle.

7. The tire casing carrier of claim 3 wherein the locking member extends in an arcuate fashion.

8. The tire casing carrier of claim 3 wherein the locking member is welded at an end to a hook.

9. The tire casing carrier of claim 3 wherein the locking member matingly receives a lip of the tire casing.

10. The tire casing carrier of claim 1 wherein a lifting device has a ratchet and a bracket which is removably connected to the frame of the vehicle.

11. The tire casing carrier of claim 3 further comprising a clamping member connected to the locking member.

12. The tire casing carrier of claim 2 wherein the strap extension splits into a pair of support members each terminating in a hook.
